(19) United States
(12) Patent Application Publication
(10) Pub. No.: US 2011/0056192 A1
(43) Pub. Date: Mar. 10, 2011

(54) TECHNIQUE FOR CONTROLLING PUMPS IN A HYDRAULIC SYSTEM

(76) Inventors: Robert Weber, Wadsworth, IL (US); Wayne George Chmiel, Norway, WI (US); Dave L. Perugini, Kenosha, WI (US); Michael Gordon Onsager, Franklin, WI (US); Joseph Helfrich, Milwaukee, WI (US)

(21) Appl. No.: 12/557,119

(22) Filed: Sep. 10, 2009

(51) Int. Cl. F15B 11/08

(52) U.S. Cl. 60/327; 60/428

(57) ABSTRACT

A hydraulic system includes a plurality of pumps that provide pressurized fluid to a plurality of hydraulic actuators some of which work more that others. That system is controlled by producing a usage value for each of the plurality of pumps which indicates an amount that the respective pump has worked. One of the pumps is assigned to each hydraulic actuator in response to the usage values. The pumps with lower usage values are assigned to hydraulic actuators which work more, so as to equalize the use of each pump. The assignment of pumps to hydraulic actuators changes with changes in the usage values for the plurality of pumps. When a given one of the plurality of hydraulic actuators is to operate, hydraulic fluid is routed from the assigned pump to that given one of the plurality of hydraulic actuators.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to hydraulic systems for excavators; and more particularly to controlling a plurality of pumps used in such hydraulic systems.

2. Description of the Related Art

Large excavators, such as power shovels, have a crawler truck on which the cab of the excavator is mounted. A boom is connected to the cab by a pivot joint that enables the boom to move up and down. The boom has a remote end to which one end of an arm is pivotally connected and a bucket is pivotally attached to the other end of the arm in turn has its own remote end to which. The bucket may be a clam-type having two pieces which open and close like a clam shell. The boom, the arm and the bucket are moved with respect to each other by separate hydraulic actuators in the form of cylinder and piston assemblies.

Large excavators have a hydraulic system with multiple pumps that can be selectively activated based on the demand for hydraulic fluid by the actuators. When deactivated, a fixed displacement pump continued was hydraulically “unloaded” by a valve that was opened to route the pump's output flow directly to the fluid reservoir. Alternatively, a variable displacement pumps was deactivated by destroking it. With those deactivation methods, however the pump still contributed to the parasitic losses as it was driven by the prime mover even when unloaded.

The multiple pump systems also typically activated and deactivated the pumps in a fixed order so that one pump always was utilized when hydraulic fluid was needed and the remaining pumps were activated in the same order as the demand for hydraulic fluid rose. Similarly as that demand decreased, the pumps were deactivated in the reverse order. As a result, the pumps were exposed to different amounts of use and thus required maintenance and replacement at different intervals.

Certain types of excavators, such as those used in mining operations, are operated continuously, 24 hours a day, and thus have to be taken out of service in order for maintenance to be performed. As a consequence, it is desirable to minimize the number of times that the excavator is removed from service.

### SUMMARY OF THE INVENTION

A hydraulic system includes plurality of pumps that provide pressurized fluid to a hydraulic actuator. The plurality of pumps are controlled by a method that measures how much each of the plurality of pumps has been used. For example, that amount of use of a given pump may be determined by measuring an amount of time that the pump operates or by measuring the aggregate amount of work that the performs. When the pump is driven by an electric motor, the amount of work is derived from the voltage and current applied to the electric motor, for example.

The demand for fluid to operate the hydraulic actuator is determined and a number of the plurality of pumps are selectively activated to supply enough fluid to meet that demand. The pumps are selectively activated in sequential order from the pump with a least amount of use to the pump with a greatest amounts of use. That activation tends to operate the pumps that have been used the least so that all the pumps will have approximately the same amount of usage and tend to require maintenance and replacement at about the same time.

Another aspect of the present invention involves a hydraulic system that has a plurality of pumps which provide pressurized fluid to a plurality of hydraulic actuators. With this system, a usage value is produced for each pump indicating an amount that the respective pump has been used. For each of the plurality of hydraulic actuators, one of the pumps is assigned to each hydraulic actuator in response to the usage values for the plurality of pumps. The pumps with lower usage values are assigned to hydraulic actuators which work more, so as to equalize the use of each pump. The assignment of pumps to hydraulic actuators changes with changes in the usage values for the plurality of pumps. When a given one of the plurality of hydraulic actuators is to operate, hydraulic fluid is routed from the assigned pump to that hydraulic actuator.

### BRIEF DESCRIPTION OF THE DRAWINGS

FIG. 1 is a side view of an excavator which incorporates the present invention;

FIG. 2 is a schematic diagram of the hydraulic system for the excavator which has a plurality of pumps driven by electric motors;

FIG. 3 is a flowchart of a software routine executed by a supervisory controller in FIG. 2 to measure the wear of the motors and pumps in the hydraulic system;

FIG. 4 is a software routine executed by the supervisory controller to vary the assignment of the different pumps to the various hydraulic actuators; and

FIGS. 5 and 6 are two tables depicting different assignments of the pumps to hydraulic functions on the excavator.

### DETAILED DESCRIPTION OF THE INVENTION

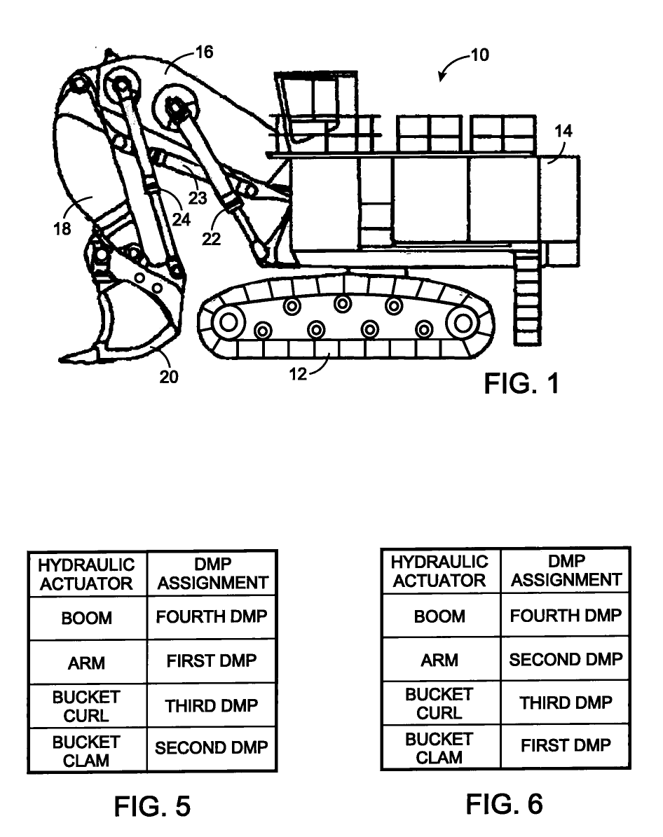

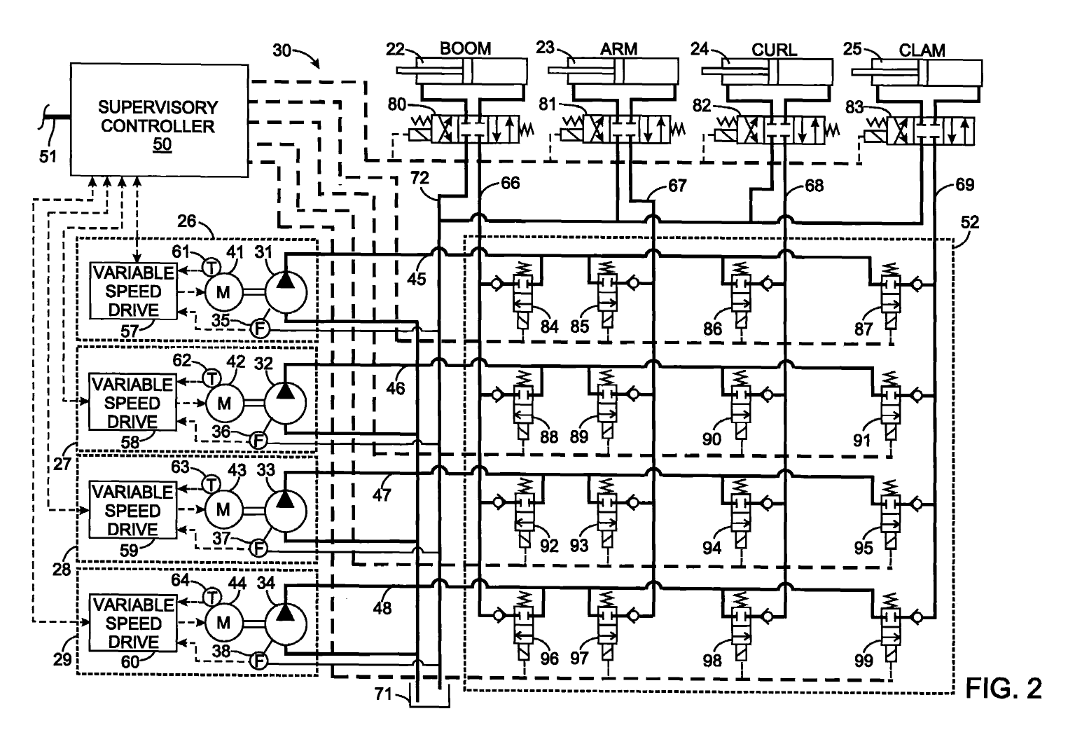

With initial reference to FIG. 1, an excavator, such as a front power shovel 10, has a crawler assembly 12 for moving the shovel across the ground. A cab 14 is pivotally mounted on the crawler tractor so as to swing in left and right. A boom 16 is pivotally mounted to the front of the cab 14 and can be raised and lowered by a boom hydraulic actuator 22 in the form of a first double-acting cylinder-piston assembly. An arm 18 is pivotally attached to the end of the boom 16 that is remote from the cab 14 and can be pivoted with respect to the boom by an arm hydraulic actuator 23 in the form of a second double-acting cylinder-piston assembly. At the remote end of the arm 18 from the boom is attached to a work tool, such as a bucket 20, that faces forward from the cab 14, hence this type of excavator is referred to as a front power shovel. The bucket 20 is pivoted or “curled” about the end of the arm 18 by a curl hydraulic actuator 24, in the form of a third double-acting cylinder-piston assembly. The bucket 20 is made up of two sections which can be opened and closed like a clam shell by a clam hydraulic actuator 25 (FIG. 2). The two bucket sections are held closed together during a digging operation and are separated in order to dump material into a truck or onto a pile.

With reference to FIG. 2, the hydraulic system 30 for operating the power shovel comprises a set of four pumps 31, 32, 33, and 34 which draw fluid from a reservoir or tank 71. Each pump 31, 32, 33, and 34 has a supply outlet that is connected to a separate primary supply lines 45, 46, 47, and 48. The pressurized fluid from the supply outlet of the first pump 31 is fed into a first primary supply line 45, the second pump 32 feeds a second primary supply line 46, the third pump 33 feeds a third primary supply line 47, and the fourth pump 34 feeds a fourth primary supply line 48. The pumps 31-34 have fixed displacements so that the amount of fluid that is pumped is directly proportional to the speed at which the pump is driven. Each of the four pumps 31, 32, 33, and 34 is driven by a separate electric motor 41, 42, 43 and 44 respectively. Each motor 41, 42, 43 and 44 is operated by a variable speed drive 57, 58, 59, and 60 which vary the frequency of the alternating current applied to the respective motor in order to operate the motor at a desired speed. Any of several well known variable speed drives can be utilized, such as the one described in U.S. Pat. No. 4,263,535, which description is incorporated herein by reference. Each combination of a pump, motor and variable speed drive forms a drive-motor-pump assembly (DMP) 26, 27, 28, and 29. It should be understood that a hydraulic system that employs the present invention may have a greater or lesser number of DMP's.

Each pump 31-34 has a case drain through which fluid leakage flows from the pump to the reservoir 71, as is well known. Each of those case drains is coupled to a reservoir return line 72 by a separate flow meter 35, 36, 37 and 38 connected to the respective variable speed drive 57, 58, 59, and 60. A separate temperature sensor 61, 62, 63 and 64 is mounted on each of the motors 41, 42, 43, and 44 respectively, to sense the temperature and provide a signal back to the associated variable speed drive 57, 58, 59, and 60. Thus in addition to controlling the speed of the associated motor, each variable speed drive also gathers data about the motor temperature and the pump drain flow.

The DMP's 26, 27, 28, and 29 and specifically the variable speed drives 57, 58, 59, and 60 are controlled by a supervisory controller 50 which is a microcomputer based device that responds to control signals from the human operator of the power shovel and other signals to control the hydraulic actuators 22, 23, 24, and 25 to operate the shovel as desired. Those signals are received by the supervisory controller 50 over a conventional control network 51. The supervisory controller responds to those signals by determining the amount of hydraulic fluid necessary to be produced by each pump 31, 32, 33, and 34 and accordingly controls the motor 41, 42, 43, and 44 that drives the respective pump is a manner well known in the art.

The four primary supply lines 45, 46, 47, and 48 feed into a distribution manifold 52 which selectively directs the fluid flow from each pump to different ones of the four hydraulic actuators 22, 23, 24, and 25. Specifically, the manifold 52 has a first actuator supply line 66 which feeds a solenoid operated first control valve 80 for the boom hydraulic actuator 22. The first control valve 80 is a three-position, four-way valve which directs fluid from the first actuator supply line 66 to one of the chambers of the cylinder of the boom hydraulic actuator 22 and drains fluid from the other cylinder chamber into the reservoir return line 72 that leads to the reservoir 71. Depending upon the position of the first control valve 80, the first hydraulic actuator 22 is driven in either of two directions to thereby raise or lower the boom 16. Similarly, the second, third, and fourth actuator supply lines 67, 68, and 69 from the distribution manifold 52 are connected by similar second, third, and fourth control valves 81, 82, and 83 to the arm hydraulic actuator 23, the curl hydraulic actuator 24, and the clam hydraulic actuator 25, respectively. The four actuator control valves 80-83 are independently operated by separate signals from the supervisory controller 50. Although the present hydraulic system 30 utilizes control valves 80-83 between the distribution manifold 52 and the hydraulic actuators 22-25, the control valves could be eliminated by incorporating their functionality into additional valves in the distribution manifold to control flow to and from each cylinder chamber.

The present distribution manifold 52 has a matrix of sixteen distribution valves 84-99. Each distribution valve couples one of the primary supply lines 45, 46, 47, or 48 to one of the actuator supply lines 66, 67, 68, or 69. Therefore, when a given distribution valve 84-99 is electrically operated by a signal from the supervisory controller 50, a path is opened between the associated primary supply line and actuator supply line, thereby applying pressurized fluid from the pump connected to that primary supply line to the control valve 80, 81, 82, or 83 connected to that actuator supply line. For example, when distribution valve 85 is activated fluid from the first pump 31 flows through the first primary supply line 45 into the second actuator supply line 67 and onward to the second control valve 81. By selectively operating one or more of the distribution valves 84-99, the output from each pump 31-34 can be used to operate each of the four hydraulic actuators 22, 23, 24, or 25. This results is a given pump being assigned to a hydraulic actuator. It should be understood that on a particular power shovel, there may be a greater or lesser number of pumps and a greater or lesser number of hydraulic actuators; in which case the distribution manifold 52 will be configured with a corresponding different number of distribution valves. For example, hydraulic motors may independently drive the left and right tracks of the crawler assembly 12 to propel the power shovel.

It also should be understood that the output from two or more pumps can be combined to supply the same hydraulic actuator 22-25. For example, if only the arm hydraulic actuator 23 is active, the output from multiple pumps can be combined so that the arm is driven to dig into the earth with maximum speed and force. When another shovel function is to operate simultaneously with the arm, one or more of the pumps previously connected to the arm function is reassigned to provide fluid to that other shovel function by redirecting the flow through the distribution manifold 52. Also should a DMP 26-29 fail, it is deactivated by shutting off the associated variable speed drive and disconnecting the associated pump by closing all the valves in the distribution manifold 52 that are connected to the respective primary supply line. In this case, fluid from the remaining pumps supplied through the distribution manifold to operate the hydraulic actuators. If, however, the output of a particular pump is not required at a given point in time, its variable speed drive is deactivated so that the motor and thus that pump do not operate.

For very large power shovels, relatively large forces encountered by the arm hydraulic actuator 23 and curl hydraulic actuator 24 during a digging operation. In addition, the arm and curl hydraulic actuators 23 and 24 tend to be operated for longer periods of time than the other hydraulic actuators. The claim hydraulic actuator 25 associated with the bucket 20 typically is significantly smaller and consumes far less hydraulic fluid. In previous power shovels, a given pump often was dedicated to supplying fluid to one of the hydraulic actuators and thus the motor-pumps combinations performed different levels of work. In other words, because the pumps and motors for the arm and the bucket curl functions perform considerably more work than other pumps and motors in the hydraulic system, those heavily worked components tended to require more maintenance and more frequent replacement than the other motors and pumps. Therefore, the different motor/pump combinations required servicing at different times at during which the entire power shovel had to be taken out of service. The resultant downtime adversely affected the power shovel's overall productivity and economy of operation.

The present invention overcomes the problems with such previous systems by dynamically changing the assignment of the DMP's to the hydraulic actuators so that each motor/pump combination is exposed to substantially the same amount of use and work. As a consequence, all the DMP's will require maintenance and possible replacement at about the same point in time. Thus, the service and replacement intervals for the DMP's are synchronized so that the maintenance intervals, mean time to repair, and mean time between failure are optimized and provide a longer mean time between failure for the entire hydraulic system. This reduces the number of service down periods over the life of the excavator and thereby increases productivity.

In order to determine the usage of the DMP's, the supervisory controller 50 gathers data regarding the operation of their motors and pumps, such as electric current and voltage applied to the motor, motor temperature, speed, torque, aggregate operating time, and amount of pump drain flow. The accumulated data is utilized to determine the relative amount of work performed by each DMP 26, 27, 28, and 29. To this end the supervisory controller 50 executes different software routines that gather and analyze the pump and motor data to estimate the remaining anticipated life of those components and the aggregate amount of use that they have provided. The term DMP is being used to refer to performance of the motor/pump combination as well as performance of the individual motor and pump therein.

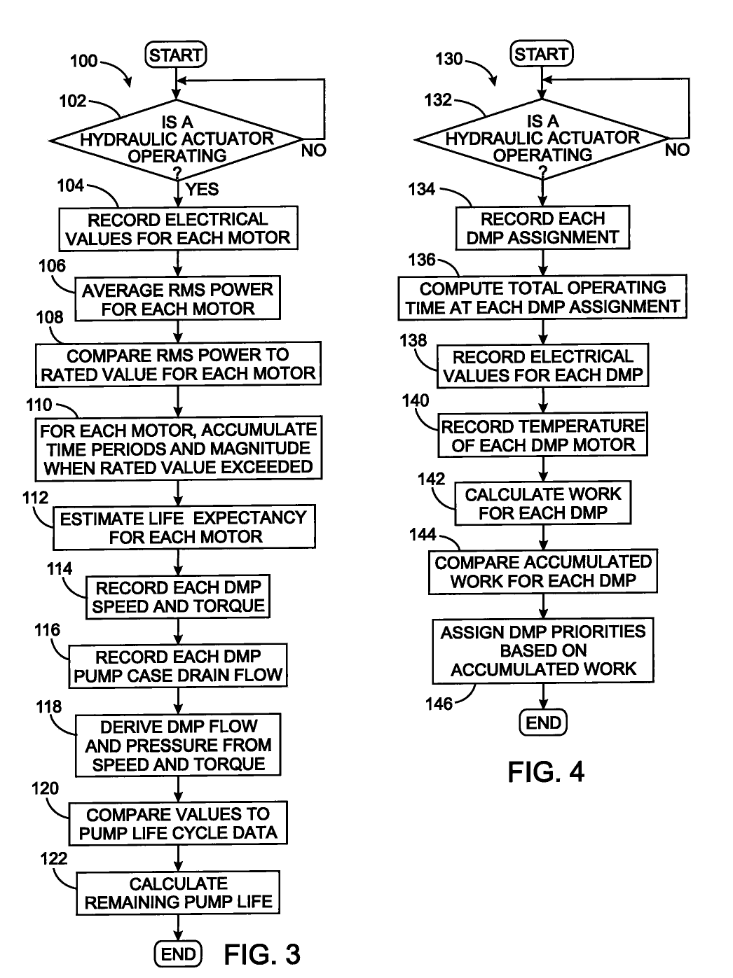

With reference to FIG. 3, a DMP life routine 100 is executed periodically on a timed-interrupt basis by the supervisory controller 50. This software routine commences at step 102 where a finding is made whether at least one actuator 22-25 of the power shovel 10 is currently being operated. The execution of the routine loops through this step until one of the hydraulic actuators 22-25 begins operating, at which time the process advances to step 104. At this juncture, the supervisory controller 50 obtains data indicating the magnitudes of the electric current and voltage that each variable speed drive 57-60 is applying to its associated motor 41-44. Each variable speed drive contains circuitry for measuring the magnitude of the voltage and current and converting those measurements into digital data for transmission to the supervisory controller 50 as is well known. Next, the recorded electrical data are used at step 106 to compute the average RMS power consumed by each motor during a predefined measurement time period. At step 108, the newly computed RMS power values are compared to the rated value for each respective motor, as specified by the motor manufacturer to determine whether the operation exceeds the rated power for that motor. If so, for each motor the magnitudes that its rated power value is exceeded are integrated at step 110 to derive a value indicative of the aggregate excessive use of the motor. Those excessive use values then are used at step 112 to calculate the life expectancy of each motor 41-44. For example, the greater the amount of time that the rated power is exceeded and the aggregate magnitude of that excess decreases the life of the motor from the nominal life expectancy specified by the motor manufacturer. The nominal life expectancy is based on the rated power level not being exceeded. An empirically derived relationship for the particular type of motor is used to calculate a how much the motor life expectancy has decreased due to the actual duration of excessive power operation and the aggregate magnitude of that excessive power. The duration of excessive power operation is based on the sampling period for the motor electrical values. The decrease in the expected motor life and the nominal life expectancy are used to project a life expectancy for each motor 41-43. That information is then stored in a table within the supervisory controller 50.

Thereafter at step 114, the DMP life routine 100 enters a section at step 116 in which the present life expectancy of each pump 31-34 is estimated. The supervisory controller 50 initially records the speed and torque of the motors 41-43, which information is derived from the electric voltage and current levels applied by the variable speed drives 57-60. Alternatively, the speed and torque data can be measured by sensors attached to the drive shaft linking a motor to a pump. The supervisory controller 50 also obtains the amounts of fluid flow exhausting from the pump case drains. Those flow rates are sensed by the flow meters 35, 36, 37, and 38 connected to circuitry in the variable speed drives 57, 58, 59, and 60 which relay the case drain flow data to the supervisory controller. Then at step 118, the amounts of fluid flow and pressure at the supply outlet of each pump 31-34 are derived from the respective speed and torque values. Specifically, the flow is the product of the speed and the fixed pump displacement. The torque correlates directly with the pump supply outlet pressure. Alternatively the fluid flow and pressure can be measured directly by sensors at the supply outlet of each pump 31-34.

At step 120, the values for the amounts of supply outlet fluid flow, pump pressure, and the case drain flow are compared with data provided by the manufacturer of the pumps to determine the present point on the life cycle for each pump. Specifically, the leakage of the pump represented by the flow from the pump case drain increases as a pump ages. In other words, the older the pump, the greater the case drain flow, however, the actual case drain flow at any point in time also is a function of the fluid flow and pressure produced at the supply outlet by the pump. That is, the case drain flow increases as the flow and pressure produced by the pump increase. A typical pump manufacturer has correlated the expected pump case drain flow for various pressure and flow amounts at different times during the life cycle of the pump. By comparing the actual fluid flow, pressure, and pump case drain flow to manufacturer specification data, the supervisory controller 50 is able to determine the remaining life of each of the pumps 31-34, at step 122. This determination is stored within the memory of the supervisory controller 50 for display to the pump operator and service personnel, as well as for determining the trends of the pump life cycle to estimate when pump maintenance and replacement will be required.

With reference to FIG. 4, the supervisory controller 50 also executes a software DMP assignment routine 130, that allocates the output of each pump 31-34 to one of the hydraulic actuators 22-25 based on the accumulated amount of use of each DMP 26-29. As noted previously, the arm and bucket curl hydraulic actuators 23 and 24 operate more frequently and demand a greater amount of force from the hydraulic system than the boom and bucket clam hydraulic actuators 24 and 25. Therefore, the DMP's that supply fluid to the arm and bucket curl hydraulic work more intensely than other DMP's. The DMP assignment routine 130 determines the aggregate amount of work that each motor/pump combination has performed and adjusts the assignment of the DMP's 26-29 to the various hydraulic actuators 22-25 to approximately equalize the work being performed. This results in all the motor/pump combinations incurring essentially the same amount of wear so that they should require maintenance and ultimately replacement at the approximately same time.

The DMP assignment routine 130 commences at step 132 where a finding is made whether the hydraulic system 30 is currently operating at least one actuator, if so, the routine advances to step 134. At that point, the present assignments of the four DMP's 26, 27, 28 and 29 to the different hydraulic actuators 22, 23, 24, and 25 is recorded as a table in the memory of the supervisory controller 50. FIG. 5 depicts an exemplary table in which for each hydraulic function one of the DMP's is designated. That table also is used by the supervisory controller 50 in opening and closing the distribution valves 84-99 in the distribution manifold 52 to direct fluid from each pump to the designated hydraulic actuator. For the exemplary table, the supervisory controller 50 would open distribution valve 96 to direct the fluid from the fourth pump 34 to the boom supply line 66, and open distribution valve 85 to direct the fluid from the first pump 31 to the arm supply line 67. Similarly distribution valve 94 is opened to direct the fluid from the third pump 33 to the curl supply line 68 and distribution valve 91 is opened to direct the fluid from the second pump 32 to the clam supply line 69.

Returning to the DMP assignment routine 130 in FIG. 4, the total amount of time that each DMP 26-29 has operated when assigned to each hydraulic actuator is determined at step 136. For each DMP, the supervisory controller 50 implements a separate timer in software that runs whenever the respective DMP is operating. This provides a cumulative record of the total time that each motor 41-44 and each pump 31-34 has operated.

At step 138 the magnitudes of electric voltage and current that the respective variable speed drive 57, 58, 59, and 60 applies to the associated motor 41, 42, 43 and 44 are read by the supervisory controller 50. Each variable speed drive 57, 58, 59, and 60 stores a digitized temperature value resulting from a signal produced by the temperature sensor 61, 62, 63 or 64 attached to the associated motor 41, 42, 43, or 44, respectively. The temperature values also are read from the variable speed drives and stored within the memory of the supervisory controller 50 at step 140.

At step 142, the electrical values read for each motor 41-44 are used to determine the amount of work that the respective DMP performed. Specifically, the current and voltage levels for a particular motor are multiplied to produce a value denoting the amount of electrical power consumed during the time interval between measurements. Not all consumed input electrical power is converted into mechanical power for driving the pump, because energy is lost as heat produced in the motor. The measured temperature of the respective motor is used to calculate the amount of the electrical power that was consumed in heating that motor, i.e., the heat power loss. Therefore, the mechanical power provided by the associated pump 31-34 is calculated by subtracting the heat power loss from the amount of electrical power consumed. The resultant mechanical power value then is integrated over the measurement interval to derive the amount of work that the pump performed. The new amount of work then is added to a sum of similar amount of work calculated previously to provide a measurement of the aggregate amount of work that the pump has performed since its installation. This work computation is performed individually for each of the pumps 31-34 and the resultant aggregate amounts of work are stored in the supervisory controller 50. At step 144, the DMP's 26-29 are ranked in order of the aggregate amount of work that each has performed.

As noted previously, the DMP's supplying the arm and curl hydraulic actuators 23 and 24 perform a greater amount of work over time than the boom and claim hydraulic actuators 22 and 25. Thus the DMP's that control the flow of fluid to the arm and curl hydraulic actuators corresponding perform a greater amount of work. The purpose of the DMP assignment routine 130 is to equalize the aggregate amounts of work that the motor/pump combinations perform so that they are subjected to substantially equal amount of wear and therefore require maintenance and ultimately replacement at approximately the same time. Doing so reduces how often the power shovel 10 must be taken out of operation.

In a standard configuration of the distribution manifold 52, a separate pump 31-34 is connected to feed fluid to a different hydraulic actuator 22-25. Which pump is connected to which hydraulic actuator is determined dynamically in response to the ranking of the DMP's based on the aggregate amount of work that each performed. The DMP to hydraulic actuator assignments are recorded as a table in the memory of the supervisory controller 50 and FIG. 5 depicts as exemplary set of those assignments. Therefore at step 146, the DMP work rankings are inspected to ensure that the DMP's with the least aggregate amounts of work are assigned to the arm and curl hydraulic actuators 23 and 24. Assume for example that upon entering step 146, the DMP to hydraulic actuator assignments are as depicted in FIG. 5, the second DMP 27 now has the greatest aggregate amount of work, and the fourth DMP 29 has the least aggregate amount of work. The supervisory controller 50 in this case will reassign the second DMP 27 to the bucket claim hydraulic actuator 25, and the fourth DMP 29 to the arm hydraulic actuator 25 as depicted in FIG. 6. The rearrangement of the DMP to hydraulic actuator assignments causes the supervisory controller 50 two change the configuration of open and closed distribution valves 86-97 to connected the pumps 31-34 in each DMP to the hydraulic actuator 22-25 designated in the assignment table.

For machines in which the different hydraulic actuators are subjected to substantially equal forces, the assignment of DMP's can be based on operating time. For example, the DMP that with the lowest aggregate amount of work is assigned to the hydraulic actuator that operates most often. Similarly the DMP that with the greatest aggregate amount of work is assigned to the hydraulic actuator that operates least often. In another variation of the present control technique, when a hydraulic actuator is operate, the inactive DMP with the lowest aggregate amount of work is assigned to provide fluid that actuator.

In another situation, a given hydraulic actuator may have a varying demand for hydraulic fluid depending on the force acting on that actuator. One DMP alone may not be able to meet all demand levels. Therefore at higher demand levels, multiple pumps are used to provide fluid to that given hydraulic actuator. Here the DMP's are assigned to the given hydraulic actuator in order from the DMP with the lowest aggregate amount of work to the DMP with the greatest aggregate amount of work. Thereafter, when the demand for hydraulic fluid from a hydraulic actuator decreases, the DMP's are unassigned in the reverse order. Specifically, the DMP with the greatest aggregate amount of work is disconnected first and the DMP with the lowest aggregate amount of work remains connected until fluid not longer is needed.

The foregoing description was primarily directed to a preferred embodiment of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

What is claimed is:

1. A method for controlling use of a plurality of pumps in a hydraulic system that includes a hydraulic actuator, said method comprising:
measuring how much each of the plurality of pumps has been used;
determining a demand for fluid to operate the hydraulic actuator;
selectively activating each of the plurality of pumps to supply sufficient fluid to satisfy the demand for fluid, wherein the plurality of pumps are activated in sequential order from the pump with a least amount of use to the pump with a greatest amounts of use.

2. The method as recited in claim 1 wherein each pump is driven by a separate electric motor and wherein measuring how much each of the plurality of pumps has been used comprises:
measuring electric current and voltage applied to the motor of each pump;
measuring a temperature of the motor of each pump;
in response to the temperature, current, and voltage deriving an amount of work performed by each pump.

3. The method as recited in claim 1 wherein measuring how much each of the plurality of pumps has been used comprises measuring an aggregate amount of work that each pump has performed.

4. The method as recited in claim 1 further comprising determining a life expectancy for a given pump in the plurality of pumps.

5. The method as recited in claim 4 wherein determining a life expectancy for a given pump comprises measuring fluid flow from a case drain port of the given pump.

6. The method as recited in claim 4 wherein determining a life expectancy for a given pump comprises determining amounts of fluid flow and pressure at a supply outlet of the given pump.

7. The method as recited in claim 4 wherein determining a life expectancy for a given pump comprises measuring an amount of drain fluid flow from a case drain port of the given pump; determining amounts of fluid flow and pressure at a supply outlet of the given pump; and deriving the life expectancy in response to the amount of drain fluid flow, the amounts of supply outlet fluid flow, and the pressure.

8. The method as recited in claim 1 wherein each pump is driven by a separate electric motor and further comprising determining a life expectancy for a given electric motor.

9. The method as recited in claim 8 wherein determining a life expectancy for a given electric motor comprises measuring power consumed by the given electric motor to produce a power measurement; and deriving a life expectancy value in response to the power measurement exceeding a power rating for the given electric motor.

10. A method for controlling use of a plurality of pumps in a hydraulic system that includes a plurality of hydraulic actuators, said method comprising:
for each of the plurality of pumps, producing a usage value which indicates an amount that the respective pump has been used;
for each of the plurality of hydraulic actuators, specifying an assigned pump selected from the plurality of pumps in response to the usage values for the plurality of pumps; and
when a given one of the plurality of hydraulic actuators is to operate, routing hydraulic fluid from the assigned pump to that given one of the plurality of hydraulic actuators.

11. The method as recited in claim 10 wherein each of the plurality of hydraulic actuators works a given amount; and pumps with relatively low usage values are assigned to hydraulic actuators that work relatively greater given amounts, and pumps with relatively high usage values are assigned to hydraulic actuators that work relatively lesser given amounts.

12. The method as recited in claim 10 wherein in response to a change the given amount that each of the plurality of pumps has been used, changing the assigned pump for at least some of the plurality of hydraulic actuators.

13. The method as recited in claim 10 wherein producing a usage value comprises measuring an amount of time that the respective pump operates.

14. The method as recited in claim 10 wherein producing a usage value comprises measuring an amount of work that the respective pump performs.

15. The method as recited in claim 10 wherein each pump is driven by an associated electric motor, and producing a usage value for the respective pump comprises measuring an amount of energy applied by the associated electric motor.

16. The method as recited in claim 15 wherein measuring an amount of energy applied by the associated electric motor comprises measuring voltage and electric current supplied to that motor.

17. The method as recited in claim 16 further comprising measuring a temperature of each motor; and measuring an amount of energy applied by the associated electric motor further comprises calculating a electric power value in response to the voltage and electric current, and subtracting from the electric power value, a value related to an amount of power that produced heat in the associated electric motor.

18. The method as recited in claim 10 further comprising determining a life expectancy for a given pump in the plurality of pumps.

19. The method as recited in claim 18 wherein determining a life expectancy for a given pump comprises measuring an amount of fluid flow from a case drain port of the given pump.

20. The method as recited in claim 18 wherein determining a life expectancy for a given pump comprises determining amounts of fluid flow and pressure at a supply outlet of the given pump.

21. The method as recited in claim 18 wherein determining a life expectancy for a given pump comprises measuring drain an amount of fluid flow from a case drain port of the given pump; determining amounts of outlet fluid flow and pressure at a supply outlet of the given pump; and deriving the life expectancy in response to the amounts of the drain fluid flow, the outlet fluid flow, and the pressure.

22. The method as recited in claim 10 wherein each pump is driven by a separate electric motor and further comprising determining a life expectancy for a given electric motor.

23. The method as recited in claim 22 wherein determining a life expectancy for a given electric motor comprises measuring power consumed by the given electric motor to produce a power measurement and deriving a life expectancy value in response to the power measurement exceeding a power rating for the given electric motor.
